(19) United States
(12) Patent Application Publication
(10) Pub. No.: US 2015/0227202 A1
(43) Pub. Date: Aug. 13, 2015

(54) APPARATUS AND METHOD FOR PROVIDING HAPTIC FEEDBACK

(71) Applicant: Nokia Corporation, Espoo (FI)

(72) Inventors: Juha BACKMAN, Espoo (FI); Catalin Gheorghiu, Helsinki (FI)

(21) Appl. No.: 14/612,254

(22) Filed: Feb. 2, 2015

(30) Foreign Application Priority Data
Feb. 11, 2014 (GB) 1402309.7

(51) Int. Cl. G06F 3/01

(52) U.S. Cl. CPC G06F 3/016

(57) ABSTRACT

An apparatus and method for providing haptic feedback, the apparatus comprising: a first conductive trace; a second conductive trace provided overlaying the first conductive trace and configured to move relative to the first conductive trace; a user input module overlaying the second conductive trace; wherein the conductive traces are configured to receive current such that when the current is provided movement of the second conductive trace provides haptic feedback via the user input module.

### TECHNOLOGICAL FIELD

Examples of the disclosure relate to an apparatus and method for providing haptic feedback. In particular they relate to an apparatus and method for providing haptic feedback via a user input module.

### BACKGROUND

Apparatus comprising user input modules are known. It is useful to enable user input modules to provide a haptic feedback to a user. For example, where the user input module comprises a touch sensitive display it may be useful to provide haptic feedback as a confirmation to a user that they have actuated the user input module.

It is useful to provide mechanisms for providing haptic feedback which can be integrated into electronic devices with user input modules.

### BRIEF SUMMARY

According to various, but not necessarily all, examples of the disclosure there may be provided an apparatus comprising: a first conductive trace; a second conductive trace provided overlaying the first conductive trace and configured to move relative to the first conductive trace; a user input module overlaying the second conductive trace; wherein the conductive traces are configured to receive current such that when the current is provided movement of the second conductive trace provides haptic feedback via the user input module.

In some examples the second conductive trace may be positioned in proximity to the first conductive trace.

In some examples the first conductive trace may provide a pattern in a first plane and the second conductive trace provides a corresponding pattern in a second plane.

In some examples the conductive traces may provide identical patterns for at least a portion of a length of the conductive traces.

In some examples the conductive traces may provide at least one of a meandering pattern, a coil pattern.

In some examples the separation between sections of current travelling in opposing directions within the first conductive trace may be greater than the separation between the first conductive trace and the second conductive trace.

In some examples the first conductive trace may be provided on a first substrate and the second conductive trace may be provided on a second substrate.

In some examples the user input module may comprise a touch sensitive display.

In some examples the apparatus may also comprise a capacitor configured to provide the current to the conductive traces.

In some examples the conductive traces may be connected in series.

In some examples the apparatus may also comprise at least one switch configured to enable the direction of current through the second conductive trace to be reversed.

In some examples the apparatus may comprise a plurality of first conductive traces arranged into pairs with a plurality of second conductive traces wherein the pairs of conductive traces are arranged in a matrix.

In some examples there may also be provided an electronic device comprising an apparatus as described above.

According to various, but not necessarily all, examples of the disclosure there may be provided a method comprising: providing a first conductive trace; providing a second conductive trace overlaying the first conductive trace and configured to move relative to the first conductive trace; providing a user input module overlaying the second conductive trace; and configuring the conductive traces to receive current such that when the current is provided movement of the second conductive trace provides haptic feedback via the user input module.

In some examples the second conductive trace may be positioned in proximity to the first conductive trace.

In some examples the first conductive trace may provide a pattern in a first plane and the second conductive trace provides a corresponding pattern in a second plane.

In some examples the conductive traces may provide identical patterns for at least a portion of a length of the traces.

In some examples the conductive traces may provide at least one of a meandering pattern, a coil pattern.

In some examples the separation between sections of current travelling in opposing directions within the first conductive trace may be greater than the separation between the first conductive trace and the second conductive trace.

In some examples the first conductive trace may be provided on a first substrate and the second conductive trace may be provided on a second substrate.

In some examples the user input module may comprise a touch sensitive display.

In some examples the method may further comprise configuring a capacitor to provide the current pulse to the conductive traces.

In some examples the method may further comprise connecting the conductive traces in series.

In some examples the method may further comprise providing at least one switch to enable the direction of current through the second conductive trace to be reversed.

In some examples the method may further comprise providing a plurality of first conductive traces arranged into pairs with a plurality of second conductive traces wherein the pairs of conductive traces are arranged in a matrix.

According to various, but not necessarily all, examples of the disclosure there may be provided examples as claimed in the appended claims.

The apparatus may be for providing haptic feedback to a user. For example the apparatus may provide a haptic feedback to a user of a device such as a touch sensitive display or other user input module.

### BRIEF DESCRIPTION

For a better understanding of various examples that are useful for understanding the brief description, reference will now be made by way of example only to the accompanying drawings in which:

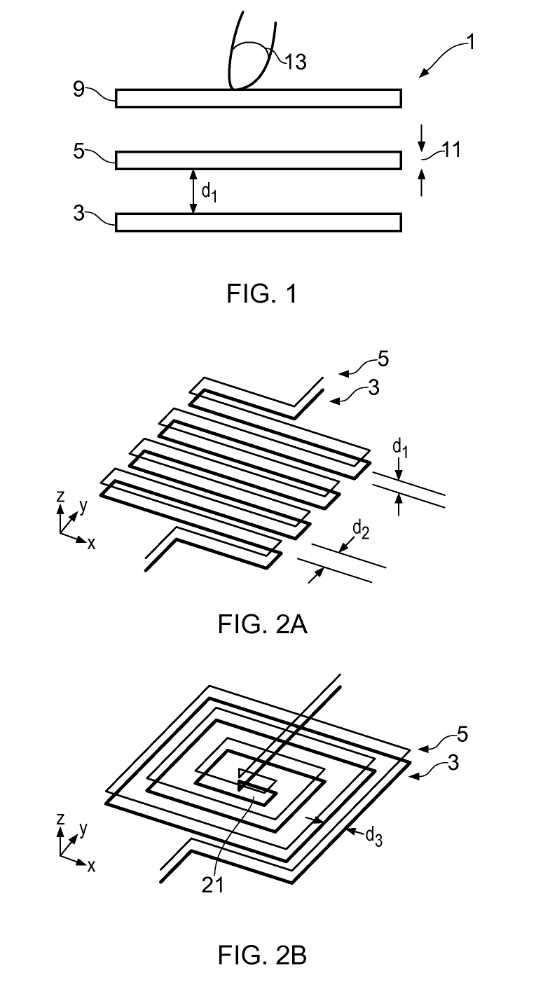

FIG. 1 illustrates a cross section through an apparatus;

FIGS. 2A to 2B illustrate example conductive traces;

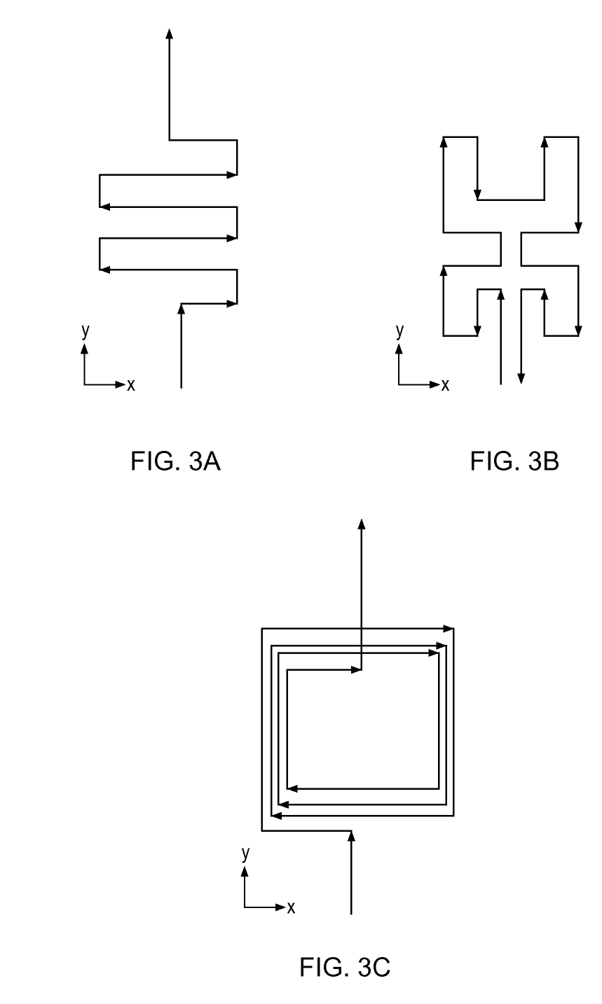

FIGS. 3A to 3C illustrate example conductive traces;

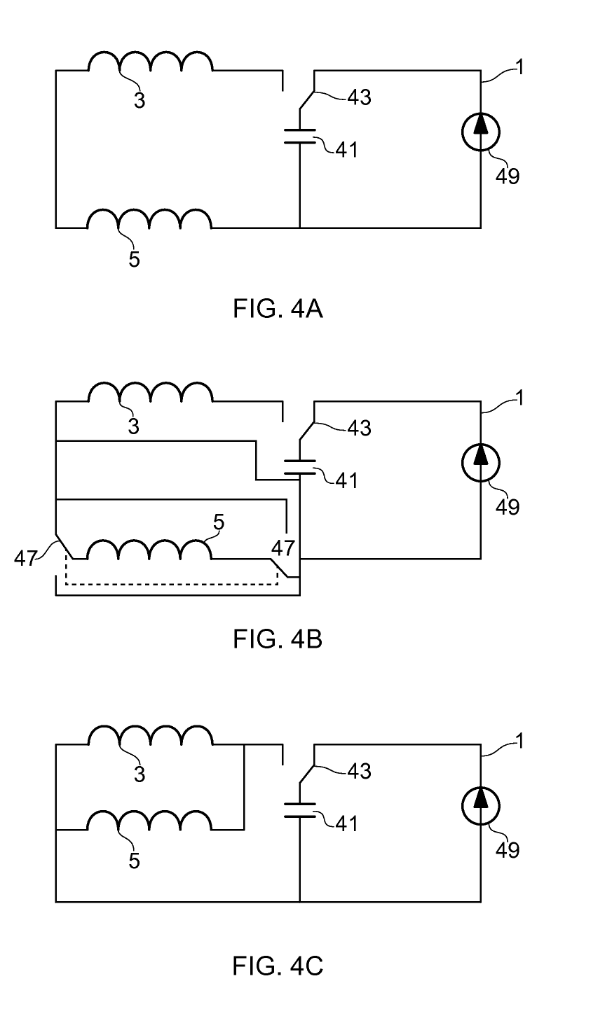

FIGS. 4A to 4C illustrate example apparatus;

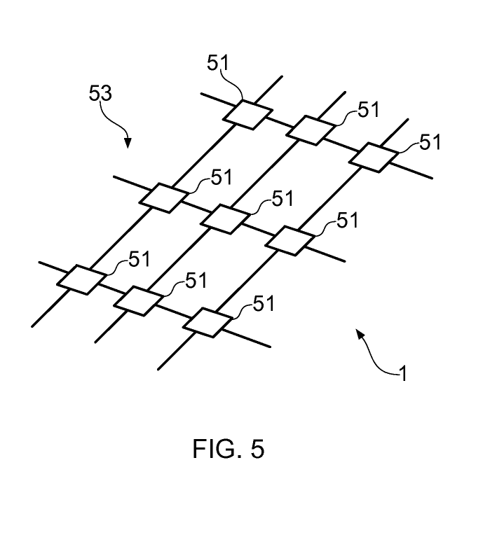

FIG. 5 illustrates an example apparatus;

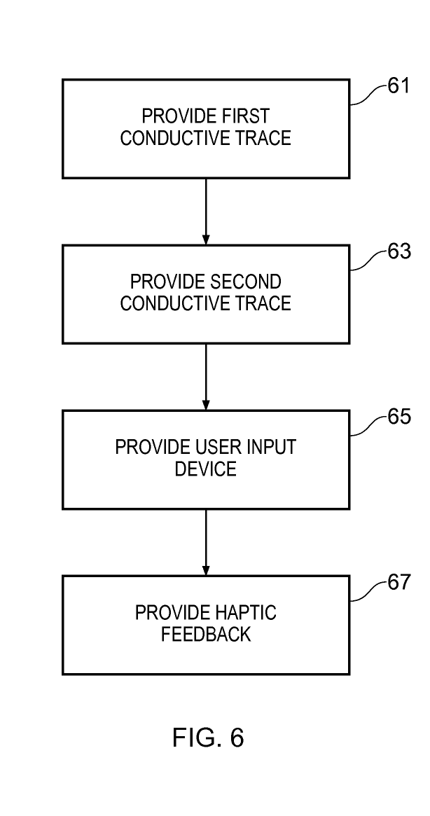

FIG. 6 illustrates a method;

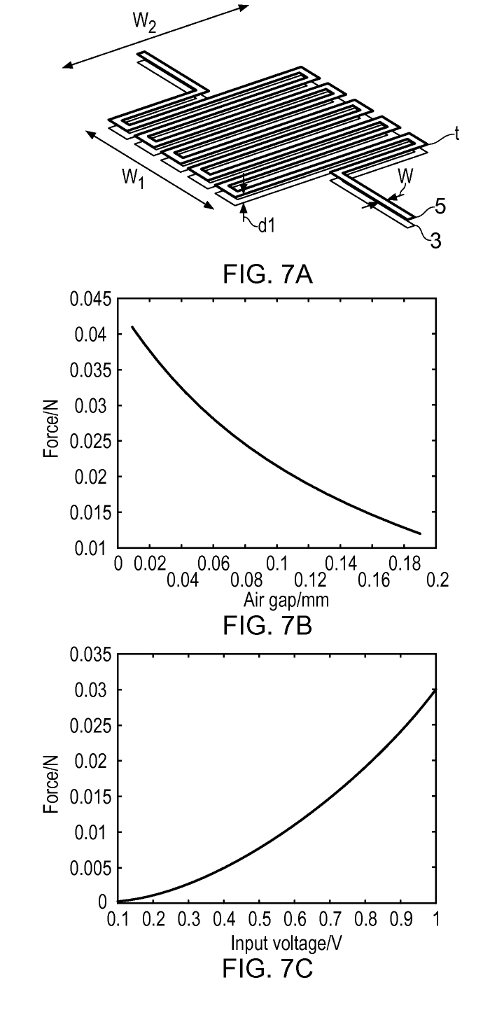

FIGS. 7A to 7C illustrate an example conductive trace and plots of the forces which may be provided by the conductive trace; and

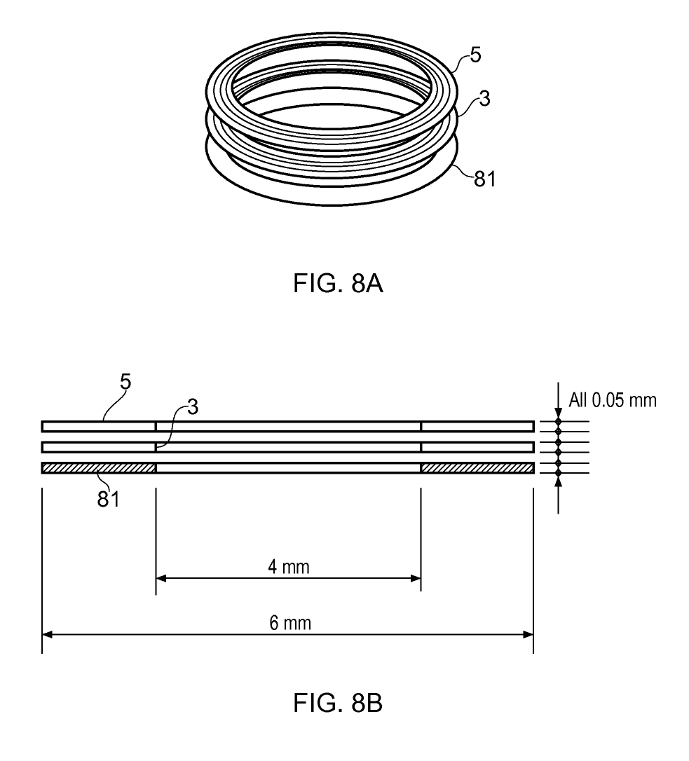

FIGS. 8A and 8B illustrate example conductive traces.

### DETAILED DESCRIPTION

The Figures illustrate an apparatus 1 comprising: a first conductive trace 3; a second conductive trace 5 provided overlaying the first conductive trace 3 and configured to move relative to the first conductive trace 3; a user input module 9 overlaying the second conductive trace 5; wherein the conductive traces 3, 5 are configured to receive current such that when the current is provided movement of the second conductive trace 5 provides haptic feedback via the user input module 9.

Examples of the disclosure provide an apparatus 1 which may be configured to enable haptic feedback to be provided to a user. The haptic feedback may comprise feedback provided by the apparatus 1 which the user can detect via their sense of touch. The haptic feedback may be configured so that the user can feel the haptic feedback when they touch a user input module 9.

The apparatus 1 may be configured to enable haptic feedback to be provided to a user when the user actuates a user input module 9. For example, the haptic feedback may comprise the displacement of a portion of the surface of a user input module 9. The user may be able to detect the displacement when they touch the user input module 9 to actuate the user input module 9.

In some examples the haptic feedback may be provided to enable a user to actuate the user input module 9. For instance a raised or indented portion may enable a user to locate items on a user input module 9 without looking at the user input module 9.

FIG. 1 schematically illustrates a cross section through an apparatus 1 according to an example of the disclosure. In the example of FIG. 1 the apparatus 1 comprises a first conductive trace 3, a second conductive trace 5 and a user input module 9. Only features referred to in the following description are illustrated in FIG. 1. It is to be appreciated that the apparatus 1 may comprise additional features that are not illustrated.

The apparatus 1 may be provided within a device such as an electronic device. The electronic device could be a device such as a mobile cellular telephone, a tablet computer, a personal computer, a camera, a gaming device, a personal digital assistant, an electronic book reader, a personal music player, a television, a non-cellular device or any other suitable electronic device which may comprise a user input module 9. The electronic device may be a handheld electronic device which can be carried in a user's hand or bag. The electronic device may be a hand held device such that it is sized and shaped so that the user can hold the electronic device in their hand while they are using the electronic device.

In the example apparatus 1 of FIG. 1 the second conductive trace 5 is provided overlaying the first conductive trace 3. The second conductive trace 5 may be provided parallel to the first conductive trace 3. The second conductive trace 5 may be provided parallel to the first conductive trace 3 so that the separation d₁ between the traces 3, 5 is equal along at least a portion of the length of the traces 3, 5. The distance d₁ may be small so that the second conductive trace 5 is positioned in proximity to the first conductive trace 3. It is to be appreciated that FIG. 1 is not drawn to scale.

The second conductive trace 5 may be configured to move relative to the first conductive trace 3. In the example of FIG. 1 the second conductive trace 5 may be configured to move in the directions of the arrow 11. The second conductive trace 5 may be configured to move in response to a force generated by the electromagnetic effects of current flowing through the conductive traces 3, 5.

The conductive traces 3, 5 may comprise any means which may be configured to provide a current path. In some examples the conductive traces 3, 5 may comprise traces of conductive material which may be printed on a substrate such as a circuit board. The conductive material may comprise copper or any other suitable material. In some examples the conductive traces may comprise wires or any other suitable means.

In some examples the first conductive trace 3 may be provided on a first substrate 3 and the second conductive trace 5 may be provided on a second substrate 3. The second substrate may be thinner than the first substrate. Having the second substrate thinner than the first substrate may reduce the separation between the first and second conductive traces 3, 5.

The second substrate 5 may be flexible to enable the second conductive trace 5 to move relative to the first conductive trace 3. In some examples the first substrate 3 may be rigid. The first substrate 3 may be rigid to prevent movement of the first conductive trace 3.

The first and second conductive traces 3, 5 may be configured to receive a pulse of current. In some examples the conductive traces 3, 5 may be configured to be connected to a power supply such as a battery or a charged capacitor which may be configured to enable a pulse of current to flow through the conductive traces 3, 5.

The conductive traces 3, 5 may be driven using a suitable signal (waveform) directly via the power supply or via a suitable amplifier. In some examples a signal generator may be provided. The signal generator may be connected to an amplifier in order to drive the conductive traces.

When current I flows through the first conductive trace 3 this creates a magnetic field B which is proportional to the current flowing though the conductive trace 3. The magnetic field B is also inversely proportional to the distance from the conductive trace 3.

BαI/d₁

Therefore the smaller the separation d₁ between the conductive traces 3, 5, the greater the magnetic field on the second conductive trace 5.

The force F exerted on the second conductive trace 5 is proportional to the current I flowing through the second conductive trace 3 and the strength of the magnetic field B.

FαIB

Therefore, if the current flowing through the first and conductive traces 3, 5 is the same, for example if the first and second conductive traces 3, 5 are connected in series, then the force F exerted on the second conductive trace 5 is proportional to the square of the current and inversely proportional to the separation of the conductive traces 3, 5.

$$F α \frac{{I}^{2}}{{d}_{1}}$$

Therefore the apparatus 1 may be arranged so that separation d₁ may be small enough and/or the current I may be large enough so that a current pulse provided to the conductive traces 3, 5 generates a large enough force to cause movement of the second conductive trace 5 relative to the first conductive trace 3. In the example of FIG. 1 the movement of the second conductive trace 5 is in the direction indicated by the arrow 11. The direction of the movement of the conductive trace 5 will depend upon the direction of the current flowing in the conductive traces 3, 5.

In the example of FIG. 1 a user input module 9 is provided overlaying the second conductive trace 5.

The user input module 9 may comprise any means which may enable a user to control a device. For example the user input module 9 may comprise a touch pad or a touch sensitive display or a portion of touch pad or a touch sensitive display. The touch pad or touch sensitive display may comprise means which may enable a user to make a user input by touching the surface of the touch pad or the touch sensitive display with an object such as their finger 13.

In some examples the user input module 9 may comprise a portion of the cover of a housing of an electronic device. The user input module may be provided on the side or back cover of an electronic device or part of a unibody. In some examples the user input module 9 may comprise a key or other region of the cover which enables a user to interact with the electronic device.

The user input module 9 may be coupled to the second conductive trace 5 so that movement of the second conductive trace 5 causes displacement of at least a portion of the surface of the user input module 9. The displacement may be sensed by a user touching the surface of the user input module 9.

At least a portion of the user input module 9 may be flexible so that movement of the second conductive trace 5 causes movement of the portion of the touch sensitive module 9 overlaying the second conductive trace 5. For example the user input module 9 may comprise a flexible upper surface of a display. This may enable haptic feedback to be provided to a user touching the user input module 9.

FIG. 1 illustrates a cross section through an apparatus and so only a portion of the conductive traces 3, 5 are illustrated. FIGS. 2A and 2B illustrate perspective views of examples of conductive traces 3, 5 which may be used in some examples of the disclosure.

In the examples of FIGS. 2A and 2B it can be seen that the second conductive trace 5 is provided overlaying the first conductive trace 3.

In the examples of FIGS. 2A and 2B the first conductive trace 3 provides a pattern in a first plane and the second conductive trace 5 provides a corresponding pattern in a second plane. In FIGS. 2A and 2B the patterns are provided in an x-y plane and the separation between the conductive traces 3, 5 extends in a z direction. The z direction may be perpendicular to the x-y plane.

In both the examples of FIGS. 2A and 2B the conductive traces 3, 5 have corresponding patterns. In some examples the conductive traces 3, 5 may provide identical patterns for at least a portion of the length of the traces 3, 5. The separation d₁ may be constant along the length of the conductive traces 3, 5. This may enable a large enough force to be exerted on the conductive traces 3, 5 when a current flows through the conductive traces 3,5 to enable a user to detect the movement of the second conductive trace 5.

In the example of FIG. 2A the conductive traces 3, 5 have a meandering pattern. The example meandering pattern of FIG. 2A comprises a portion which extends towards the positive x direction followed by a portion extending towards the positive y direction and then a portion extending towards the negative x direction which is then followed by another portion extending towards the positive y direction. This pattern is repeated along the length of the conductive traces 3, 5. This pattern provides a conductive trace which extends generally in the y direction.

The meandering pattern enables a longer length of conductive trace 3, 5 to be provided in a small cross sectional area. The length of the conductive trace 3, 5 is much longer than the width of the area covered by the conductive traces 3, 5 in the x and y directions.

The patterns of the conductive traces 3, 5 may be arranged so that the magnetic fields generated by adjacent or nearby sections of the conductive traces 3, 5 do not cancel each other out. In some examples the patterns may be arranged so that the separation d₂ between sections of current travelling in opposing directions within the first conductive trace 3 is greater than the separation d₁ between the first conductive trace 3 and the second conductive trace 5.

In the example of FIG. 2A the meandering pattern comprises portions which extend in the positive x direction and the negative x direction. When current is flowing through the conductive traces it will be flowing in opposing directions in these sections. The distance d₂ may be large enough so that the magnetic fields generated by respective sections of the conductive traces 3, 5 do not cancel each other out.

FIG. 2B illustrates another example of a pattern for the conductive traces 3, 5. In FIG. 2B the conductive traces 3, 5 provide a coiled pattern. In FIG. 2B the conductive traces 3, 5 provide a flat wound coil pattern. The example coiled pattern of FIG. 2B comprises a square spiral pattern in the x-y plane.

In the coiled pattern of FIG. 2B the adjacent portions of the conductive traces 3, 5 are not carrying current in the opposing directions and so the cancellation of the magnetic field is less significant than in the meandering pattern of FIG. 2A. This may enable the distance d₃ between portions of the conductive traces 3, 5 to be small compared to the distance d₂. This may increase the current densities in conductive traces 3, 5 of the pattern of FIG. 2B compared to the pattern of FIG. 2A.

The example of FIG. 2B requires a conductor to be provided to the centre 21 of the coil as illustrated in FIG. 2B. This may be provided using a multilayer circuit board or a flex connector or any other suitable means.

FIGS. 3A to 3C illustrate more examples of conductive traces which may be used in example apparatus 1.

The example of FIG. 3A has a meandering pattern similar to the pattern of FIG. 2A. The example meandering pattern of FIG. 3A comprises a portion which extends towards the positive x direction followed by a portion extending towards the positive y direction and then a portion extending towards the negative x direction which is then followed by another portion extending towards the positive y direction. This pattern is repeated along the length of the conductive traces 3, 5. This pattern provides a conductive trace which extends generally in the y direction.

The separation between the adjacent portions of the conductive traces 3, 5 may be selected so as to reduce the effect of the cancellation of the magnetic field caused by the current travelling in opposing directions.

The example of FIG. 3B has an alternative meandering pattern. The example meandering pattern of FIG. 3B comprises a plurality of loops. The shapes and dimensions of the loops may be selected so as to reduce the effect of the cancellation of the magnetic field caused by the current travelling in opposing directions.

The example of FIG. 3C has a coiled pattern similar to the coiled pattern of FIG. 2B. In the example of FIG. 3C the spacing between portions of the conductive traces 3, 5 carrying currents in opposing directions may be selected so as to reduce the effect of the cancellation of the magnetic field.

It is to be appreciated that the pattern of the conductive traces 3, 5 may be designed taking into account factors such as the dimensions, weight, location and mechanical coupling of the user input module 9 relative to the conductive traces 3, 5.

FIGS. 4A to 4C illustrate circuit diagrams of an example apparatus 1.

In the example of FIG. 4A the conductive traces 3, 5 may be connected in series to capacitor 41. The capacitor 41 is connected to a power supply 49. The power supply 41 could be a battery of an electronic device or any other suitable power supply. The power supply may be configured to charge the capacitor 41. In some examples the power supply 49 may have a current limit.

The apparatus also comprises a switch 43 which may be configured to connect the capacitor 41 either to the power supply 49 or the conductive traces 3, 5. The switch 43 may comprise an electronically controlled switch. The switch may comprise any suitable means such as a field effect transistor (FET), a bipolar transistor or any other type of switch.

When the switch 43 connects the capacitor 41 to the power supply 49 the power 49 supply charges the capacitor 41. When haptic feedback is needed the switch 43 is controlled to disconnect the power supply 49 and connect the capacitor 41 to the conductive traces, 3, 5. This causes a pulse of current to be provided to the conductive traces 3, 5. The pulse of current causes movement of the second conductive trace 5 as described above.

FIG. 4B illustrates another example the apparatus 1. The example apparatus 1 of FIG. 4B comprises a capacitor 41, a switch 43 and a power supply 49 as described above in relation to FIG. 4A.

The example apparatus 1 of FIG. 4B also comprises additional switches 45 and 47 which may be arranged to switch the polarity of the second conductive trace 5. This enables the direction of the current flow in the second conductive trace 5 to be changed which can change the direction of the force exerted on the second conductive trace 5. This may then change the direction of the movement of the second conductive trace 5 when the current is provided.

FIG. 4C illustrates another example apparatus 1 which also comprises a capacitor 41, a switch 43 and a power supply 49 which may be as described above.

In the example apparatus 1 of FIG. 4C the conductive traces 3, 5 are connected in parallel. The example apparatus 1 of FIG. 4C may enable short pulses of high current to be provided to the traces 3, 5.

In the examples of FIGS. 4A to 4C a pulse of current is provided to the conductive traces 3, 5. This causes a temporary displacement of the second conductive trace 5 however this is sufficient to provide haptic feedback to a user.

In the examples of FIGS. 4A to 4C the capacitor 41 may be configured to provide a pulse of current to the conductive traces 3, 5. This may enable a large current to be provided to the conductive traces 3, 5 without drawing high current from the power supply 49.

FIG. 5 illustrates another example apparatus 1. The apparatus 1 of FIG. 5 comprises a plurality of pairs 51 of conductive traces 3, 5. The apparatus 2 of FIG. 5 comprises a plurality of additional first conductive traces 3 arranged into pairs 51 within a plurality of additional second conductive traces 5. The conductive traces 3, 5 may be as described above with reference to any of FIGS. 1 to 4B. The pairs of conductive traces 51 are arranged in a matrix 53 comprising a plurality of rows and a plurality of columns.

Any pair 51 of conductive traces 3, 5 within the matrix 53 may be made active be selecting the appropriate row and column. This may enable haptic feedback to be provided at a plurality of locations on a user input module 9.

As each pair 51 in the matrix 53 may contribute to voltage loss the number of pairs 51 in any row and column may be selected so as to ensure that sufficient force is still provided at an active pair.

FIG. 6 illustrates an example method. The method may be used to provide an apparatus 1 as described above in relation to FIGS. 1 to 5. The method comprises, at block 61, providing a first conductive trace 3.

The method comprises, at block 63 providing a second conductive trace 5 overlaying the first conductive trace 3 and configured to move relative to the first conductive trace 3.

The method also comprises, at block 65, providing a user input module 9 overlaying the second conductive trace 5.

The method also comprises, at block 67, configuring the conductive traces 3, 5 to receive current such that when the current is provided the movement of the second conductive trace 5 provides haptic feedback via the user input module 9.

It is to be appreciated that the illustration of a particular order to the blocks does not necessarily imply that there is a required or preferred order for the blocks and the order and arrangement of the block may be varied. Furthermore, it may be possible for some blocks to be omitted.

FIGS. 7A to 7C illustrate example conductive traces 3, 5 which may be used in an apparatus 1 and plots of the forces generated by current flowing through the conductive traces 3, 5.

FIG. 7A illustrates example conductive traces 3, 5. In this example the conductive traces are arranged in a meandering pattern similar to patterns described above in relation to FIGS. 2A and 3A. It is to be appreciated that in other examples other patterns may be used.

The width of the conductive traces 3, 5 is 0.2 mm and the thickness t of the conductive traces 3, 5 is 0.05 mm. It is to be appreciated that other widths and thicknesses may be used in other examples. Providing conductive traces 3, 5 with larger cross sectional areas may increase the current through the conductive traces 3, 5 and so provide a larger force.

The widths of the pattern W₁ and W₂ are 5 mm so the area of the pattern is 25 mm².

FIG. 7B provides a plot of force as the separation d₁ (Air gap/mm) between the two conductive traces 3, 5 is varied from 0.01 mm to 0.19 mm. It can be seen that the force is inversely proportional to the separation d₁ between the conductive traces.

The forces provided are of the order of tens of millinewtons. However as this force is provided over a small area of 25 mm² the surface pressure is sufficient to provide haptic feedback to a user. Furthermore the force is greater for smaller separation d₁ and so it is beneficial to keep the distance between the conductive traces 3, 5 as small as possible. This enables a thin apparatus 1 for providing haptic feedback to be provided.

FIG. 7C provides a plot of force as the separation d₁ between the two conductive traces 3, 5 is kept constant at 0.05 mm but the voltage is varied from 0.1V to 1V.

It can be seen that the force is proportional to the square of the voltage and so providing a high drive voltage to the apparatus 1 enables a larger force to be provided.

FIGS. 8A and 8B illustrate conductive traces according to another example of the disclosure. FIG. 8A illustrates a perspective view of the conductive traces 3, 5 and FIG. 8B illustrates a cross section through the conductive traces 3, 5.

In the example of FIGS. 8A and 8B the conductive traces 5, 3 comprise coils. A ferromagnetic ring 81 is provided underneath the first conductive trace 3. The ferromagnetic material may comprise any suitable material such as iron or nickel. The ferromagnetic ring 81 may increase the magnetic field strength for the conductive traces 3, 5. The ferromagnetic ring 81 may be thin so that it does not significantly increase the overall thickness of the apparatus.

The above examples provide an apparatus which can be used to provide haptic feedback to a user through a user input module 9. For example a touch sensitive display may display user selectable icons or keys. When a user selects or actuates an icon or key the apparatus 1 may be controlled to provide haptic feedback to the user. The haptic feedback may comprise displacement of the surface of the touch sensitive display which the user may sense through their finger 13. The haptic feedback may provide the user with confirmation that they have selected or actuated a key or icon. The haptic feedback may be provided in the location in which the key or icon is displayed.

Example dimensions for the conductive traces 5, 3 and the ferromagnetic ring 81 are provided in FIG. 8B. In this example the width of the coils is 6 mm and the width of the gap in the centre of the coils is 4 mm. The thickness of each of the coils and the ferromagnetic ring 81 is 0.05 mm. The separation between the first coil and the ferromagnetic ring 81 is 0.05 mm and the separation between the two coils is also 0.05 mm. It is to be appreciated that other dimensions may be used in other examples of the disclosure.

As the apparatus 1 does not require any magnets or moving parts the apparatus 1 can be very thin and so can be added to user input modules without significantly increasing the volume.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one.” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus comprising:
a first conductive trace;
a second conductive trace provided overlaying the first conductive trace and configured to move relative to the first conductive trace;
a user input module overlaying the second conductive trace;
wherein the conductive traces are configured to receive current such that when the current is provided movement of the second conductive trace provides haptic feedback via the user input module.

2. The apparatus as claimed in claim 1, wherein the second conductive trace is positioned in proximity to the first conductive trace.

3. The apparatus as claimed in claim 1, wherein the first conductive trace provides a pattern in a first plane and the second conductive trace provides a corresponding pattern in a second plane.

4. The apparatus as claimed in claim 1, wherein the conductive traces provide identical patterns for at least a portion of a length of the conductive traces.

5. The apparatus as claimed in claim 1, wherein the conductive traces provide at least one of a meandering pattern, a coil pattern.

6. The apparatus as claimed in claim 1, wherein the separation between sections of current travelling in opposing directions within the first conductive trace is greater than the separation between the first conductive trace and the second conductive trace.

7. The apparatus as claimed in claim 1, wherein the first conductive trace is provided on a first substrate and the second conductive trace is provided on a second substrate.

8. The apparatus as claimed in claim 1, further comprising a capacitor configured to provide the current to the conductive traces.

9. The apparatus as claimed in claim 1, wherein the conductive traces are connected in series.

10. The apparatus as claimed in claim 9, comprising at least one switch configured to enable the direction of current through the second conductive trace to be reversed.

11. The apparatus as claimed in claim 1, comprising a plurality of additional first conductive traces arranged into pairs with a plurality of additional second conductive traces wherein the pairs of conductive traces are arranged in a matrix.

12. A method comprising:
providing a first conductive trace;
providing a second conductive trace overlaying the first conductive trace and configured to move relative to the first conductive trace;
providing a user input module overlaying the second conductive trace; and
configuring the conductive traces to receive current such that when the current is provided movement of the second conductive trace provides haptic feedback via the user input module.

13. The method as claimed in claim 12, wherein the second conductive trace is positioned in proximity to the first conductive trace.

14. The method as claimed in claim 12, wherein the first conductive trace provides a pattern in a first plane and the second conductive trace provides a corresponding pattern in a second plane.

15. The method as claimed in claim 12, wherein the separation between sections of current travelling in opposing directions within the first conductive trace is greater than the separation between the first conductive trace and the second conductive trace.

16. The method as claimed in claim 12, wherein the first conductive trace is provided on a first substrate and the second conductive trace is provided on a second substrate.

17. The method as claimed in claim 12, further comprising configuring a capacitor to provide the current pulse to the conductive traces.

18. The method as claimed in claim 12, further comprising connecting the conductive traces in series.

19. The method as claimed in claim 18, further comprising providing at least one switch to enable the direction of current through the second conductive trace to be reversed.

20. The method as claimed in claim 12, further comprising providing a plurality of additional first conductive traces arranged into pairs with a plurality of additional second conductive traces wherein the pairs of conductive traces are arranged in a matrix.
